(19) United States
(12) Patent Application Publication
(10) Pub. No.: US 2018/0014557 A1
(43) Pub. Date: Jan. 18, 2018

(54) ANIMAL FEED COMPOSITION AND METHOD OF MAKING SAME

(71) Applicant: Benemilk Oy, Raisio (FI)

(72) Inventors: Feng Wan, Issaquah, WA (US); Timothy Martin Londergan, Seattle, WA (US)

(73) Assignee: Benemilk Oy, Raisio (FI)

(21) Appl. No.: 15/547,784

(22) PCT Filed: Feb. 2, 2016
(86) PCT No.: PCT/US2016/016147

§ 371 Date: Jul. 31, 2017

Related U.S. Application Data
(60) Provisional application No. 62/111,006, filed on Feb. 2, 2015.

(51) Int. Cl. A23K 20/158; A23K 40/00; A23K 20/20; A23K 20/174; A23K 20/195; A23K 20/142; A23K 20/105; A23K 50/10

(52) U.S. Cl. CPC A23K 20/158; A23K 20/105; A23K 50/10; A23K 40/00; A23K 20/142; A23K 20/195; A23K 20/174; A23K 20/20

(57) ABSTRACT

Fatty acid compositions for animal feed include a fatty acid component and a surfactant component, wherein the fatty acid composition melts at not less than 40° C. and the fatty acid component has an Iodine Value no greater than 45. A method for making a fatty acid composition for animal feed includes combining a fatty acid component with a surfactant component to provide a fatty acid composition, and forming the fatty acid composition into solid beads.

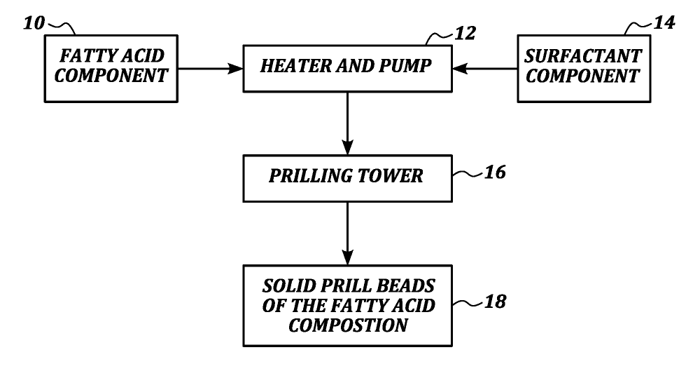

### CROSS-REFERENCE TO RELATED APPLICATION

This application claims priority to U.S. Application No. 62/111,006, filed Feb. 2, 2015, which is expressly incorporated herein by reference in its entirety.

### BACKGROUND

Increasing production and fat content of milk obtained from lactating ruminants have been major goals for dairy farmers. Additional milk production per ruminant is beneficial because it results in a higher yield, thereby increasing profits. Increased milk fat and milk protein are desirable because milk solids have a higher economic value and can be used in highly desirable food products, such as cheese, yogurt, and the like.

### SUMMARY

In one aspect, the disclosure provides fatty acid compositions for animal feed. In some embodiments, a fatty acid composition for animal feed comprises a fatty acid component and a surfactant component. In some embodiments, the fatty acid composition melts at not less than about 40° C. In some embodiments the fatty acid component has an Iodine Value not greater than about 45.

In some embodiments, the fatty acid composition is in free flowing solid form. In some embodiments, the fatty acid composition is formed as prilled solid beads or solid flakes.

In some embodiments, the solid bead containing the fatty acid composition may have an outer layer and an inner core. In some embodiments, the percentage of the surfactant component in the outer layer may be substantially similar to the percentage of the surfactant component in the inner core. In some embodiments, the percentage of the surfactant component in the outer layer may be higher than the percentage of the surfactant component in the inner core. In some embodiments, the percentage of the surfactant component in the outer layer may be less than the percentage of the surfactant component in the inner core. In some embodiments, the surfactant component in the outer layer may differ from the surfactant component in the inner core. In some embodiments, the fatty acid component in the outer layer may differ from the fatty acid component in the inner core.

In some embodiments, the fatty acid composition melts at not less than about 50° C., about 60° C., about 65° C., or about 70° C.

In some embodiments, the fatty acid composition has a moisture level of not greater than about 2% by weight. In some embodiments, the fatty acid composition has a moisture level of not greater than about 0.1% by weight, or about 0.01% by weight.

In some embodiments, the fatty acid composition has a particle size not greater than 10 mm. In some embodiments, the fatty acid composition has a particle size from about 1 μm to about 10 mm. In some embodiments, the fatty acid composition has a particle size from about 10 μm to about 2 mm. In some embodiments, the fatty acid composition has an average particle size of about 0.5 mm, about 1 mm, or about 2 mm. In some embodiments, the fatty acid has a mean particle size of about 0.5 mm, about 1 mm, or about 2 mm. In some embodiments, the fatty acid composition has a particle size not greater than 5 mm.

In some embodiments, a weight/weight ratio of the surfactant component to the fatty acid component is about 1:100 to about 1:1. In some embodiments, a weight/weight ratio of the surfactant component to the fatty acid component is about 1:20 to about 1:1. In some embodiments, a weight/weight ratio of the surfactant component to the fatty acid component is about 1:10 to about 1:2. In some embodiments, a weight/weight ratio of the surfactant component to the fatty acid component is about 1:10 to about 1:3.

In some embodiments, the fatty acid composition comprises no more than 20% by weight of the surfactant component. In some embodiments, the fatty acid composition comprises no more than 5%, 10%, 15%, or 25% by weight of the surfactant component. In some embodiments, the fatty acid composition comprises from about 0.01% to about 30% by weight of the surfactant component.

In some embodiments, the fatty acid composition further comprises a nutritional agent or a carrier. In some embodiments, the carrier comprises a porous carrier material. In some embodiments, the porous carrier material comprises protein, grain, roughage, or metal-organic framework.

In some embodiments, the nutritional agent comprises an antioxidant, a bioactive agent, a flavoring agent, a colorant, a glucogenic precursor, a vitamin, a mineral, an amino acid, a trace element, or derivatives thereof.

In some embodiments, the antioxidant comprises ethoxyquin (1,2-dihydro-6-ethoxy-2,2,4-trimethylquinoline), BHA (butylated hydroxyanisole), BHT (butylated hydroxytoluene), ascorbic acid, ascorbyl palmitate, benzoic acid, calcium ascorbate, calcium propionate, calcium sorbate, citrate acid, dilauryl thiodipropionate, distearyl thiodipropionate, erythorbic acid, formic acid, methylparaben, potassium bisulphite, potassium metabisulphite, potassium sorbate, propionic acid, propyl gallate, propyl paraben, resin guaiae, sodium ascorbate, sodium benzoate, sodium bisulphite, sodium metabisulphite, sodium nitrite, sodium propionate, sodium sorbate, sodium sulphite, sorbic acid, stannous chloride, sulphur dioxide, THBP (trihydroxy-butyrophenone), TBHQ (tertiary-butylhydroquinone), thiodipinic acid, tocopherols, polyphenol, carotenoid, flavonoids, flavones, quinones, or derivatives thereof.

In some embodiments, the bioactive agent comprises a prebiotic agent, a probiotic agent, or an antimicrobial agent. In some embodiments, the prebiotic agent comprises fructo-oligosaccahrides, inulin, galacto-oligosaccahride, mannan-oligosaccahride, a yeast, a component of a yeast, a yeast extract, or a combination thereof. In some embodiments, the probiotic agent comprises lactic acid-producing bacteria, live yeast cells, yeast culture, enzymes, protease, amylase, or a combination thereof In some embodiments, the antimicrobial agent comprises monensin, bambermycin, lasalocid, salinomycin, a sesquiterpene, a terpene, an alkaloid, an essential oil, or their derivative thereof.

In some embodiments, the glucogenic precursor comprises glycerol, propylene glycol, propanediol, polyol, calcium or sodium propionate, or a derivative thereof.

In some embodiments, the vitamin comprises biotin, vitamin A, vitamin C, vitamin D, vitamin E, vitamin H, vitamin K, vitamin B₁, vitamin B₂, vitamin B₃, vitamin B₅, vitamin B₆, vitamin B₇, vitamin B₉, vitamin B₁₂, or vitamin Bₚ, or a derivative thereof.

In some embodiments, the mineral comprises a derivative of calcium, sodium, magnesium, phosphorous, potassium, manganese, zinc, selenium, copper, iodine, iron, cobalt, or molybdenum. In some embodiments, the mineral comprises an amino acid chelated or glycinated mineral or selenium yeast. In some embodiments, the mineral comprises an organic mineral derivative.

In some embodiments, the amino acid is carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, selenomethionine, serine, tyrosine, or derivatives thereof.

In some embodiments, the surfactant component may include a non-ionic emulsifier or an ionic emulsifier. In some embodiments, the surfactant component comprises an emulsifier having a hydrophilic-lipophilic balance value of about 5 to about 25. In some embodiments, the surfactant component comprises an emulsifier having a hydrophilic-lipophilic balance value of from about 10 to about 20. In some embodiments, the surfactant component comprises an emulsifier having a hydrophilic-lipophilic balance value of about 5, about 8, about 15 or about 18.

In some embodiments, the surfactant component comprises esters or salts of long chain fatty acid. In some embodiments, the surfactant component comprises lecithin, soy lecithin, cephalin, castor oil ethoxylate, sorbitan mono-, di-, or tri-oleate, tallow ethoxylate, lauric acid, polyethylene glycol, or derivatives thereof. In some embodiments, the surfactant component comprises calcium stearoyl dilaciate, polyglycerol ester, glycerol ester, sorbitan ester, polysorbitan ester, polyethylene glycol ester, sugar ester, mono-, di- or triglyceride, acetylated mono-, di- or triglyceride, acetylated monoglyceride, lactylated monoglyceride, phospholipid, or derivatives thereof. In some embodiments, the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidized soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, polysorbate 20, polysorbate 40, polysorbate 60,or derivatives thereof. In some embodiments, the sodium or potassium or calcium salts of fatty acids comprises sodium or potassium or calcium salts of distilled palm fatty acids.

In some embodiments, the surfactant component comprises a surfactant derived from oleic acid. In some embodiments, the surfactant component comprises a non-ionic oleate ester derived surfactant. In some embodiments, the surfactant component comprises an ionic oleic acid derived surfactant. In some embodiments, the surfactant component comprises sodium oleate, potassium oleate, calcium oleate, ammonium oleate, sorbitan oleate, sorbitan mono-, di- or trioleate, polycorbitan oleate, polysorbitan mono-, di- or trioleate, glyceryl oleate, methyl oleate, ethyl oleate, PEG oleate, triethanolamine oleate (TEA oleate), polysorbitan oleate, or a combination thereof.

In some embodiments, the fatty acid component may have a melting point not less than about 45° C. In some embodiments, the fatty acid component melts at not less than about 50° C., about 60° C., about 65° C., or about 70° C.

In some embodiments, the fatty acid component comprises free fatty acid, salt or ester of fatty acid, fatty acid ester, mono-, di-, or triglyceride, or a combination thereof. In some embodiments, the fatty acid component comprises by weight, at least, about 70%, 75%, 80%, 85%, 90%, 95%, 98% or 99% of free fatty acid.

In some embodiments, the fatty acid component comprises a rumen stable fatty acid. In some embodiments, the fatty acid component comprises by weight, at least, about 70%, 75%, 80%, 85%, 90%, 95%, 98% or 99% of rumen stable fatty acid. In some embodiments, the fatty acid component comprises, by weight, at least about 70%, 75%, 80%, 85%, 90%, 95%, 98% or 99% of saturated fatty acid. In some embodiments, the saturated fatty acid may be free fatty acid. In some embodiments, the saturated fatty acid may be in ester form.

In some embodiments, the fatty acid component comprises by weight, at least, about 70%, 80%, 85%, 90%, 95%, 98%, or 99% of a palmitic acid compound by weight. In some embodiments, the palmitic acid compound comprises free palmitic acid, palmitate mono-, di-, or triglyceride, one or more salts of palmitic acid. In some embodiments, the salt of palmitic acid comprises sodium palmitate, calcium palmitate, magnesium palmitate, ammonium palmitate, zinc palmitate, aluminum palmitate, copper palmitate, iron palmitate, chromium palmitate, selenium palmitate, or a combination thereof. In some embodiments, the fatty acid component comprises by weight, at least, about 70%, 80%, 85%, 90%, 95%, 98% or 99% of free palmitic acid by weight.

In some embodiments, the fatty acid component comprises a stearic acid compound. In some embodiments, the stearic acid compound comprises free stearic acid, stearate mono-, di- or triglyceride, sodium stearate, calcium stearate, magnesium stearate, or ammonium stearate.

In some embodiments, the fatty acid component consists essentially of a palmitic acid compound and a stearic acid compound. In some embodiments, the fatty acid component consists essentially of free palmitic acid and free stearic acid having a weight/weight ratio from about 10:1 to about 1:10. In some embodiments, the weight/weight ratio is from about 6:4 to about 4:6. In some embodiments, the weight/weight ratio is from about 8:2 to about 2:8.

In some embodiments, the fatty acid component comprises an oleic acid compound. In some embodiments, the oleic acid compound comprises free oleic acid, an oleic acid ester, mono-, di-, or triglyceride of oleic acid, a high oleic content oil, or a combination thereof. In some embodiments, the fatty acid component comprises from about 1% to about 50% by weight of the oleic acid compound. In some embodiments, the high oleic content oil may have an oleic content not less than 40% by weight. In some embodiments, the high oleic content oil may have an oleic content not less than about 50%, about 60%, about 70%, or about 80% by weight.

In some embodiments, the fatty acid component comprises oil. The oil may be vegetable oil, plant oil, or animal oil. In some embodiments, the fatty acid component comprises from about 1% to about 50% by weight of the oil.

In some embodiments, the fatty acid component comprises olive oil, pecan oil, canola oil, peanut oil, macadamia oil, sunflower oil, corn oil, cottonseed oil, flaxseed oil, palm oil, soybean oil, grape seed oil, sea buckthorn oil, chicken fat, turkey fat, lard, or a combination thereof. In some embodiments, the fatty acid component comprises from about 1% to about 40% by weight of canola oil. In some embodiments, the fatty acid component comprises free palmitic acid and canola oil at a weight/weight ratio from about 50:1 to about 1:1.

In some embodiments, the fatty acid component has a moisture level no greater than about 2%, about 1%, about 0.5%, or about 0.1% by weight.

In some embodiments, the fatty acid component comprises unsaponifiable matter no greater than about 45%, about 25%, about 15%, or about 2% by weight.

In some embodiments, the fatty acid component has an Iodine Value not greater than about 45, about 30, about 25, about 15, about 5, about 1, or about 0.5. In some embodiments, the fatty acid component has an Iodine Value from about 5 to about 15. In some embodiments, the fatty acid component has an Iodine Value from about 10 to about 30.

In some embodiments, the disclosure provides a fatty acid composition for animal feed consists essentially of a fatty acid component and a surfactant component, wherein the fatty acid composition melts at not less than 40° C., and wherein the fatty acid component has an Iodine Value not greater than 45.

In some embodiments, the disclosure provides a fatty acid composition for ruminant feed consists of a fatty acid component and a surfactant component, wherein the fatty acid composition melts at not less than 50° C., and wherein the fatty acid component has an Iodine Value not greater than 30.

In some embodiments, the disclosure provides a fatty acid composition for ruminant feed comprises about 70% to about 99.99% by weight of a fatty acid component, about 0.01% to about 30% by weight of a surfactant component, wherein the fatty acid composition melts at not less than 50° C., and wherein the fatty acid component has an Iodine Value not greater than 30. In some embodiments, the fatty acid composition can have no more than about 2% by weight water. In some embodiments, the fatty acid composition melts at not less than 40° C.

In another aspect, the disclosure provides methods for making a fatty acid composition for animal feed. In some embodiments, the method includes combining a fatty acid component with a surfactant component to provide a fatty acid composition and forming the fatty acid composition into solid beads. In some embodiments, the method further comprises heating the fatty acid composition into liquid form before forming the fatty acid composition into solid beads. In some embodiments, the fatty acid component and the surfactant component are combined in liquid form. In some embodiments, forming the fatty acid composition into solid beads comprises prilling the fatty acid composition into solid beads.

### BRIEF DESCRIPTION OF THE DRAWINGS

The FIGURE is a flow diagram of an illustrative method of preparing a fatty acid composition including a fatty acid component and a surfactant component.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art.

Unless otherwise indicated, percents are weight percents and ratios are weight/weight ratios.

The following terms shall have, for the purposes of this application, the respective meanings set forth below.

An “animal” may be any house based or farm based animal. An example animal may be an animal raised for meat or for milk.

A “ruminant” is generally a suborder of mammal with a multiple chamber stomach that gives the animal the ability to digest cellulose-based food by softening it within a first chamber (rumen) of the stomach and to regurgitate the semi-digested mass to be chewed again by the ruminant for digestion in one or more other chambers of the stomach. Examples of ruminants include, but are not limited to, lactating animals such as cattle, goats and sheep. Cattle may include dairy cows, which are generally animals of the species Bos taurus. The milk produced by ruminants is widely used in a variety of dairy-based products.

The present disclosure generally relates to fatty acid compositions, animal feed mixtures, ruminant feed mixtures, the dietary compositions made therefrom, and to the methods for making the dietary compositions that can be fed to animal. The dietary compositions may be configured to improve various aspects of animal production including, for example, animal growth, animal reproduction or milk production. For instance, some embodiments provide that the dietary compositions may increase the amount of milk production, increase the milk fat content or yield, increase the milk protein content or yield, or all three. Specific compositions described herein may include animal feed mixtures, ruminant feed mixtures, supplements, or the like. According to some embodiments, the dietary compositions may include liquids, solids or combinations thereof, such as dry particles, pellets, liquid suspensions, emulsions, slurries, pastes, gels, or the like.

When a ruminant consumes feed, the fat in the feed is modified by the rumen to provide a milk fat profile that is different from the profile of fat in the feed. Fats that are not inert in the rumen may decrease feed intake and rumen digestibility of the feed material. Milk composition and fat quality may be influenced by the ruminant's diet. For example, oil feeding (the feeding of vegetable oils, for example) is generally believed to have negative effects on both rumen function and milk formation. As a result of oil feeding, the milk protein concentration may decrease, the milk fat concentration may decrease, and the proportion of trans fatty acids may increase. These results have been connected with various negative milk characteristics, such as an increase in the harmful low-density lipoprotein (LDL) cholesterol and a decrease in the beneficial high-density lipoprotein (HDL) cholesterol in human blood when the milk is consumed. In addition, the properties of the milk fat during industrial milk processing may be weakened. A high level of polyunsaturated fatty acids in milk can also cause taste defects and preservation problems. A typical fatty acid composition of milk fat may contain more than about 70% by weight saturated fatty acids and a total amount of trans fatty acids may be from about 3% to about 10% by weight. When vegetable oil is added into the feed, the proportion of trans fatty acids may rise to more than about 10% by weight.

One solution to diminishing the detrimental effect of oil and fat is to minimize the fatty acid hydrogenation in rumen. Fatty acid hydrogenation can be decreased, for example, by protecting fats with formaldehyde-treated casein. Another alternative is to feed the ruminant fatty acid calcium salts whereby hydrogenation in the rumen can be decreased. However, fatty acid salts typically have a pungent taste that may result in decreased feed intake by the ruminant. In addition, the salts may also disturb certain processes for forming the feed into pellets.

A fatty acid component, described herein, may allow for the transfer of a fatty acid from the feed via the digestive tract into the blood circulation of a ruminant. This may improve the milk fat, the energy efficiency of milk production and the utilization of energy by the ruminant, which positively impact the milk production and the milk protein. According to some embodiments, the dietary composition may be configured to enhance fat synthesis in the mammary gland by bringing milk fat components to the cell such that energy consumed in the fat synthesis in the mammary gland is reduced. As a result, glucose may be used more efficiently for lactose production causing increased milk production. The milk protein content may increase because there is no need to produce glucose from amino acids. In addition, the ruminant may not lose weight at the beginning of the lactation period, thereby improving the fertility of the ruminant.

A surfactant component, described herein, may enhance rumen function when digested by a ruminant. For example, the surfactant component may increase the emulsification of ruminal liquid, the growth rate of rumen microbes, the number of ruminal microorganisms, the activity of enzymes secreted by ruminal microbes, or fermentation of cellulosic materials, which may lead to increased digestibility of roughages or crude fibers in rumen and increases feed efficiency. In some embodiments, the ruminal microbes may include without limitation microbial protease and cellulase. In some embodiments, the cellulosic materials may include without limitation fibers, silage, and roughages. The surfactant component may also change the contents and proportion of volatile fatty acids and enhance the feed efficiency and performance by improving the rumen fermentation characteristics. Additionally or alternatively, the surfactant component, described herein, may improve the digestibility of the fatty acid component or a subcomponent thereof when an animal consumes the fatty acid composition. For example, the surfactant component or any part thereof may aid in the micelle formation of the fatty acid component in the animal's digestive tract, enhance the emulsification process, and/or facilitate the digestion and/or absorption of the fatty acid component.

The FIGURE depicts a schematic illustration of an example method of making fatty acid compositions for an animal feed. One embodiment of the method employed for making solid beads of a fatty acid composition is referred to as “prilling.” Prilling, also called “spray chilling,” “spray cooling,” or “spray congealing,” generally refers to a process of spraying droplets through nozzles and allowing droplets to congeal in mid-air as they fall from the top of a prilling tower toward a collection surface. Air may be circulated upward through the tower to aid in congealing the droplets into a solid. The size and shape of the droplets may be affected by the height of the tower, the nozzle size, and the nozzle shape. For example, larger sized droplets may require a higher tower than smaller sized droplets. The droplets tend to congeal without agglomerating, and the surface tension of the liquid droplets results in a generally rounded bead surface. In some embodiments, the beads may be round or oval shaped.

Referring to block 10, a fatty acid component, herein described, is heated to a temperature sufficient to melt the fatty acid component using a heater, block 12. The temperature of the fatty acid component leaving the heater can be at or slightly above the melt temperature of the fatty acid component. A temperature at or slightly above the melt temperature requires less tower height for the process of congealing. A surfactant component, block 14, can be introduced with the fatty acid component to be heated and melted simultaneously with the fatty acid component. Alternatively, the surfactant component can be combined with the fatty acid component after the heater, provided that the introduction of the surfactant component does not cause the fatty acid component to congeal or otherwise solidify prematurely. In this case, liquid surfactant components may be used. The liquid comprising the fatty acid component and surfactant component can be pumped via a pump, block 12. Then, the liquid is distributed through a droplet-producing device at the top of the prilling tower, block 16. As the droplets fall in the tower, the droplets will congeal and solidify into beads by the time they reach the bottom of the tower. The resulting solid prilled beads are a fatty acid composition having a fatty acid component and a surfactant component, block 18.

In some embodiments, the particles may be manufactured with an encapsulation process producing solid beads having at least an outer layer and an inner core. In some embodiments, the particles may be manufactured with encapsulation prilling process in which the core material and the shell material are sprayed from different nozzles. In some embodiments, the particles may be manufactured with curtain coating encapsulation process. Other example processes may include, without limitation, extrusion, co-extrusion, pan coating, fluidized bed, and coacervation.

In some embodiments, the solid bead may have a homogeneous composition. In some embodiments, the solid bead may have a layered structure. In some embodiments, the compositions in different layers may differ. In some embodiments, the difference in the layers may be in chemical compositions. In some embodiments, the difference in the layers may be in the concentrations.

In some embodiments, the bead may have an outer layer and an inner core. In some embodiments, the percentage of the surfactant component in the outer layer may be substantially similar to the percentage of the surfactant component in the inner core. In some embodiments, the percentage of the surfactant component in the outer layer may be higher than the percentage of the surfactant component in the inner core. In some embodiments, the percentage of the surfactant component in the outer layer may be less than the percentage of the surfactant component in the inner core. In some embodiments, the surfactant component in the outer layer may differ from the surfactant component in the inner core. In one example, the outer layer may contain a first surfactant and the inner core may contain a second surfactant, and the first surfactant and the second surfactant may be different. In another example, the surfactants in the outer layer and inner core may have the same chemical compositions but with different concentrations.

In some embodiments, the fatty acid component in the outer layer may differ from the fatty acid component in the inner core. In some embodiments, the difference may be in the chemical composition. In some embodiments, the difference may be in the concentration. For example, the outer layer may have lower percentage of the fatty acid component than the inner core. Or, the outer layer may contain a first fatty acid and the inner core may have a second fatty acid; and the first fatty acid differs from the second fatty acid.

In some embodiments, the method includes combining a fatty acid component with a surfactant component to provide a fatty acid composition and forming the fatty acid composition into solid beads. In some embodiments, the method further comprises heating the fatty acid composition into liquid form before forming the fatty acid composition into solid beads. In some embodiments, the fatty acid component and the surfactant component are combined in liquid form. In some embodiments, forming the fatty acid composition into solid beads comprises prilling the fatty acid composition into solid beads.

In some embodiments, the fatty acid composition includes a fatty acid component and a surfactant component. In some embodiments, the fatty acid composition melts at not less than 40° C. In some embodiments, the fatty acid component has an Iodine Value not greater than 45. In some embodiments, the fatty acid composition can consist essentially of a fatty acid component and a surfactant component, wherein the fatty acid composition melts at not less than 40° C.; and the fatty acid component has an Iodine Value not greater than 45. In some embodiments, the fatty acid composition can consist of a fatty acid component and a surfactant component, wherein, the fatty acid composition melts at not less than 50° C.; and the fatty acid component has an Iodine Value not greater than 30. In some embodiments, the fatty acid composition can comprise about 70% to about 99.99% by weight of a fatty acid component; about 0.01% to about 30% by weight of a surfactant component. The fatty acid composition melts at not less than 50° C., and wherein the fatty acid component has an Iodine Value not greater than 30. In some embodiments, the fatty acid composition can have no more than about 2% by weight water. In some embodiments, the fatty acid composition melts at not less than 40° C.

The fatty acid compositions of a fatty acid component and a surfactant component can be used in the making of an animal feed mixture.

In some embodiments, the fatty acid composition is in a free flowing solid form. In some embodiments, the fatty acid composition is formed as prilled solid beads. In some embodiments, the fatty acid composition is formed as solid flakes.

In some embodiments, the fatty acid composition melts at not less than about 50° C., about 60° C., about 65° C., or about 70° C. In some embodiments, the fatty acid composition has a moisture level of not greater than about 2%, about 1%, about 0.5% or about 0.1% by weight. In some embodiments, the fatty acid composition has a moisture level of not greater than about 0.1%, or about 0.01% by weight.

In some embodiments, the fatty acid composition includes particles having a particle size not greater than 10 mm. In some embodiments, the fatty acid composition includes particles having a particle size from about 1 μm to about 10 mm. In some embodiments, the fatty acid composition includes particles having a particle size from about 10um to about 2 mm. In some embodiments, the fatty acid composition includes particles having a particle size of about 0.1 mm, about 0.5 mm, about 1 mm, or about 2 mm. In some embodiments, the fatty acid composition includes particles having an average particle size of about 0.1 mm, about 0.5 mm, about 1 mm or about 2 mm. In some embodiments, the fatty acid composition includes particles having a mean particle size of about 0.1 mm, about 0.5 mm, about 1 mm or about 2 mm. In some embodiments, the fatty acid composition has a particle size not greater than 5 mm.

In some embodiments, the fatty acid composition may have a weight/weight ratio of the surfactant component to the fatty acid component of about 1:100 to about 1:1, or about 1:20 to about 1:1, or about 1:10 to about 1:2, or about 1:10 to about 1:3.

In some embodiments, the fatty acid composition can comprise no more than 25%, 20%, 15%, 10%, 8%, 5% or 2% by weight of the surfactant component. In some embodiments, the fatty acid composition can comprise from about 0.01% to about 30% by weight of the surfactant component.

In some embodiments, the fatty acid composition can further comprise a nutritional agent or a carrier, such as a porous carrier material. Depending on the nature of the nutritional agent, the nutritional agent can be added to the fatty acid component before, during, or after the heating process.

In some embodiments, the porous carrier material can include protein, grain, roughage, or a metal-organic framework.

In some embodiments, the nutritional agent can comprise an antioxidant, a bioactive agent, a flavoring agent, a colorant, a glucogenic precursor, a vitamin, a mineral, an amino acid, a trace element, or derivatives thereof.

In some embodiments, the antioxidant to be added to the fatty acid composition can include ethoxyquin (1,2-dihydro-6-ethoxy-2,2,4-trimethylquinoline), BHA (butylated hydroxyanisole), BHT (butylated hydroxytoluene), ascorbic acid, ascorbyl palmitate, benzoic acid, calcium ascorbate, calcium propionate, calcium sorbate, citrate acid, dilauryl thiodipropionate, distearyl thiodipropionate, erythorbic acid, formic acid, methylparaben, potassium bisulphite, potassium metabisulphite, potassium sorbate, propionic acid, propyl gallate, propyl paraben, resin guaiae, sodium ascorbate, sodium benzoate, sodium bisulphite, sodium metabisulphite, sodium nitrite, sodium propionate, sodium sorbate, sodium sulphite, sorbic acid, stannous chloride, sulphur dioxide, THBP (trihydroxy-butyrophenone), TBHQ (tertiary-butylhydroquinone), thiodipinic acid, tocopherols, polyphenol, carotenoid, flavonoids, flavones, quinones, or derivatives thereof.

In some embodiments, the bioactive agent can include a prebiotic agent, a probiotic agent, an antimicrobial agent or combinations thereof. Prebiotic agents may include fructo-oligosaccahrides, inulin, galacto-oligosaccahride, mannan-oligosaccahride, a yeast, a component of a yeast, a yeast extract, or a combination thereof. Probiotic agents may include, without limitation, lactic acid-producing bacteria, live yeast cells, yeast culture, enzymes such as protease and amylase, or a combination thereof. Antimicrobial agents may include, without limitation, monensin, bambermycin, lasalocid, salinomycin, a sesquiterpene, a terpene, an alkaloid, an essential oil, or their derivatives.

In some embodiments, the glucogenic precursor can include glycerol, propylene glycol, propanediol, polyol, calcium or sodium propionate, or a derivative thereof.

In some embodiments, vitamins can include biotin, vitamin A, vitamin C, vitamin D, vitamin E, vitamin H, vitamin K, vitamin B₁, vitamin B₂, vitamin B₃, vitamin B₅, vitamin B₆, vitamin B₇, vitamin B₉, vitamin B₁₂, vitamin Bₚ, or a derivative thereof.

In some embodiments, minerals can include derivatives of calcium, sodium, magnesium, phosphorous, potassium, manganese, zinc, selenium, copper, iodine, iron, cobalt, or molybdenum. In some embodiments, the mineral is an amino acid chelated or glycinated mineral or selenium yeast. In some embodiments, the mineral is an organic mineral derivative.

Amino acids may be an essential, non-essential, common, uncommon, synthetic or natural amino acid. In some embodiments, amino acids can include carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, selenomethionine, serine, tyrosine, or derivatives thereof.

The flavoring agent can be any natural or synthetic flavoring agent. In some embodiments, the flavoring agent comprises a fruit extract, a fruit flavor, an essential oil, or a combination thereof. In some embodiments, the flavoring agent comprises ethyl methylphenylglycidate, isoamyl acetate, isoamyl acetate limonene, malic acid, allyl hexanoate, ethyl propionate, cinnamic aldehyde, acetophenone, an essential oil, or a combination thereof.

The coloring agent can be any natural or synthetic coloring agent. In some embodiments, the coloring agent comprises a food coloring, a fruit extract, a plant extract, or an essential oil. In some embodiments, the coloring agent comprise curcumin, turmeric, anthocyanin, phycocyanin, lutein, lycopene, capsanathin, annatto, beta-carotenen, paprika oleoresin, carmine, cochineal, carminic acid, beta-apo-8′ carotenol, methyl ester of beta-apo-8′ carotenoic acid, canthaxanthin, chlorophyll, riboflavin, lactoflavin, caramel, saffron, betanine, curcumene, crocin, lucin, flavonoid, flavanone, quinone, antioxidant, or a combination thereof. In some embodiments, the coloring agent comprises carrot oil, cohineal extract, beet juice or extract, red cabbage juice or extract, graph juice or extract, graph color extract, grape skin extract, paprika, paprika oleoresin, turmeric oleoresin, vegetable juice, fruit juice, cotton seed flour. In some embodiments, the coloring agent comprises FD&C blue no. 1 or 2, FD&C green no. 3, FD&C red no. 3 or 40, FD&C yellow no. 5 or 6, Orange B, or citrus red no. 2. In some embodiments, the coloring agent comprises titanium dioxide or iron oxide.

The surfactant component can include a non-ionic or an ionic emulsifier. In some embodiments, the emulsifier can have a hydrophilic-lipophilic balance (HLB) value of about 5 to about 25. In some embodiments, the emulsifier can have a hydrophilic-lipophilic balance (HLB) value of about 10 to about 20. For example, the emulsifier can have a hydrophilic-lipophilic balance (HLB) value of about 1, 2, 3, 4, 5, 7, 8, 9, 10, 11, 12, 13, 14, 15, 16, 17, 18, 19, or 20. In some embodiments, the emulsifier can have a hydrophilic-lipophilic balance (HLB) value of not greater than about 20. In some embodiments, the HLB value provides an indication of the degree to which a surfactant component is hydrophilic or lipophilic. HLB values can be determined formulaically by assigning values to certain regions of the surfactant molecule. The HLB value can be determined by one of several well-known methods, including, for example, Griffin's method.

The emulsifier may be an ester or salt of a long chain fatty acid. The long chain fatty acid may be any saturated or unsaturated fatty acid having from about 4 to about 30 carbons. The example long chain fatty acid may include C16:0, C18:0, C18:1, C18:2, C28:3, C20:0, C20:1, C20:2, C20:3, C20:4, C20:5, C22:0, C22:4, or any combination thereof.

In some embodiments, the surfactant component can include lecithin, soy lecithin, cephalin, castor oil ethoxylate, sorbitan mono-, di-, or tri-oleate, polysorbitan mono-, di-, or tri-oleate, tallow ethoxylate, lauric acid, polyethylene glycol, or derivatives thereof.

In some embodiments, the surfactant component can include calcium stearoyl dilaciate, polyglycerol ester, glycerol ester, sorbitan ester, polysorbitan ester, polyethylene glycol ester, sugar ester, mono-, di-, or triglyceride, phospholipids, acetylated monoglyceride, lactylated monoglyceride, or derivatives thereof.

In some embodiments, the surfactant component can include polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids, polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, polysorbate 20, polysorbate 40, polysorbate 60, or derivatives thereof. In some embodiments, the sodium or potassium or calcium salts of fatty acids comprises sodium or potassium or calcium salts of distilled palm fatty acids.

In some embodiments, the surfactant component comprises a surfactant derived from oleic acid. The surfactant derived from oleic acid may be a non-ionic oleate ester derived surfactant or an ionic oleic acid derived surfactant. In some embodiments, the surfactant component comprises sodium oleate, potassium oleate, calcium oleate, ammonium oleate, sorbitan oleate, sorbitan mono-, di- or trioleate, polycorbitan oleate, polysorbitan mono-, di- or trioleate, glyceryl oleate, methyl oleate, ethyl oleate, PEG oleate, triethanolamine oleate (TEA oleate), polysorbitan oleate, or a combination thereof.

In some embodiments, the fatty acid component may have a melting point not less than about 45° C. In some embodiments, the fatty acid component melts at not less than about 50° C., about 60° C., about 65° C., or about 70° C. In some embodiments, the fatty acid component has a melting point from about 50° C. to about 70° C.

The fatty acid component may include free fatty acid, salt or ester of fatty acid, fatty acid ester, mono-, di-, or triglyceride, or a combination thereof. In some embodiments, the fatty acid component may include at least about 70%, 75%, 80%, 85%, 90%, 95%, 98%, or 99% by weight of free fatty acid.

In some embodiments, the fatty acid component can include a rumen stable fatty acid. In some embodiments, fatty acid component include at least about 70%, 75%, 80%, 85%, 90%, 95%, 98%, or 99% by weight of rumen stable fatty acid. In some embodiments, the fatty acid component comprises at least about 70%, 75%, 80%, 85%, 90%, 95%, 98% or 99% by weight of saturated fatty acid. In some embodiments, the saturated fatty acid may be free fatty acid. In some embodiments, the saturated fatty acid may be in ester form.

In some embodiments, the fatty acid component includes at least about 70%, 80%, 85%, 90%, 95%, 98%, or 99% by weight of a palmitic acid compound. The palmitic acid compound is not limited by this disclosure, and may include one or more of a conjugated palmitic acid, unconjugated palmitic acid, free palmitic acid, palmitate mono-, di- or triglyceride, one or more salts of palmitic acid, or a palmitic acid derivative. In some embodiments, the salt of palmitic acid comprises sodium palmitate, calcium palmitate, magnesium palmitate, ammonium palmitate, zinc palmitate, aluminum palmitate, copper palmitate, iron palmitate, chromium palmitate, selenium palmitate or a combination thereof. Palmitic acid, also known as hexadecanoic acid, has a molecular formula of CH₃(CH₂)₁₄CO₂H. Non-limiting examples of palmitic acid derivatives include palmitic acid esters, palmitic acid amides, palmitic acid salts, palmitic acid carbonates, palmitic acid carbamates, palmitic acid imides, and palmitic acid anhydrides. In some embodiments, the fatty acid component comprises at least about 70%, 80%, 85%, 90%, 95%, 98% or 99% of free palmitic acid by weight.

In some embodiments, the palmitic acid compound can include free palmitic acid, palmitate mono-, di-, or triglyceride, or one or more salts of palmitic acid. In some embodiments, the salt of palmitic acid can include sodium palmitate, calcium palmitate, magnesium palmitate, ammonium palmitate, zinc palmitate, aluminum palmitate, copper palmitate, iron palmitate, chromium palmitate, selenium palmitate, or a combination thereof. In some embodiments, the fatty acid component includes at least 90% or at least 95% of free palmitic acid by weight.

In some embodiments, the fatty acid component includes a stearic acid compound. In some embodiments, the stearic acid compound can include free stearic acid, stearate mono-, di- or triglyceride, sodium stearate, calcium stearate, magnesium stearate, ammonium stearate, conjugated stearic acid, unconjugated stearic acid, and stearic acid derivatives. Stearic acid, also known as octadecanoic acid, has a molecular formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, and stearic acid anhydrides.

In some embodiments, the fatty acid component can consist essentially of a palmitic acid compound and a stearic acid compound. In some embodiments, the fatty acid component can include a palmitic acid compound and a stearic acid compound. In some embodiments, the fatty acid component can consist essentially of free palmitic acid and free stearic acid having a weight/weight ratio from about 10:1 to about 1:10, a ratio from about 6:4 to about 4:6, or a ratio from about 8:2 to about 2:8.

In some embodiments, the fatty acid component comprises an oleic acid compound. In some embodiments, the oleic acid compound comprises free oleic acid, an oleic acid ester, mono-, di- or triglyceride of oleic acid, a high oleic oil, or a combination thereof. In some embodiments, the fatty acid component comprises from about 1% to about 50% by weight of the oleic acid compound. In some embodiments, the high oleic content oil may have an oleic content not less than 40% by weight. In some embodiments, the high oleic content oil may have an oleic content not less than about 50%, about 60%, about 70%, or about 80% by weight. In some embodiments, the fatty acid component comprises from about 1% to about 50% by weight of the high oleic oil. In some embodiments, the fatty acid component comprises from about 1% to about 50% by weight of the oleic acid compound.

In some embodiments, the fatty acid component comprises oil. The oil may be plant based or animal based. The oil may be vegetable oil, plant oil, or animal oil. In some embodiments, the fatty acid component may include not less than about 30%, 35%, 40%, 50%, 60% or 70% by weight of the oil. In some embodiments, the fatty acid component comprises from about 1% to about 50% by weight of the oil.

In some embodiments, the fatty acid component comprises olive oil, pecan oil, canola oil, peanut oil, macadamia oil, sunflower oil, corn oil, cottonseed oil, flaxseed oil, algal oil, palm oil, soybean oil, grape seed oil, sea buckthorn oil, chicken fat, turkey fat, lard, or a combination thereof. In some embodiments, the fatty acid component comprises from about 1% to about 50% by weight of oil. In some embodiments, the fatty acid component comprises from about 1% to about 40% by weight of canola oil. In some embodiments, the fatty acid component comprises free palmitic acid and canola oil at a weight/weight ratio from about 50:1 to about 1:1.

In some embodiments, the fatty acid component may include a fatty acid salt, a fatty acid ester, a fatty acid amide, a fatty acid anhydride, or a fatty acid alcohol. In some embodiments, the fatty acid component may include one or more free fatty acids and/or glycolipids.

In some embodiments, a fatty acid salt may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

In some embodiments, a fatty acid ester includes, for example, a fatty acid ester in a form of RCOOR′. R may be any saturated or unsaturated alkyl group including, without limitation, C10, C12, C14, C16, C18, C20, and C24. R′ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl, a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

In some embodiments, a fatty acid amide may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

In some embodiments, a fatty acid anhydride may generally refer to a compound which results from the condensation of a fatty acid with a carboxylic acid. Illustrative examples of carboxylic acids that may be used to form a fatty acid anhydride include acetic acid, propionic acid, benzoic acid, and the like.

In some embodiments, a fatty acid alcohol refers to a fatty acid having straight or branched, saturated, radical groups with 3-30 carbon atoms, and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the fatty acid component can have a moisture level of not greater than about 2%, about 1%, about 0.5% or about 0.1% by weight.

In some embodiments, the fatty acid component can include unsaponifiable matter no greater than about 45%, about 25%, about 15%, or about 2% by weight.

In some embodiments, the fatty acid component can have an Iodine Value not greater than about 45, about 30, about 25, about 20, about 15, about 10, about 5, about 1 or about 0.5. In some embodiments, the fatty acid component has an Iodine Value from about 5 to about 15. In some embodiments, the fatty acid component has an Iodine Value from about 10 to about 30. The Iodine Value is also sometimes referred to in the literature as the Iodine Number. The Iodine Value provides a measure of the unsaturation of a chemical material. Accordingly, the fatty acid component may include some unsaturated fatty acid compounds. The Iodine Value is a measure of iodine absorbed in a given amount of time by the fatty acid component. For example, the Iodine Value can represent the number of grams of iodine consumed by 100 grams of the fatty acid component. The lower the Iodine Value is, the lower the degree of unsaturation. A well-known method of determining the Iodine Value is the Wijs Method. However, the disclosure is not limited to using any one specific method of determining the Iodine Value. It is also possible that other methods of determining the degree of unsaturation may not involve the use of iodine or another halogen. It is therefore intended herein that the “Iodine Value” gives a representation of the degree of unsaturation by whatever method, and is not to be construed as limited solely to the iodine method.

In the description herein, reference is made to the accompanying drawings, which form a part hereof. In the FIGURES, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the FIGURE, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of plural, singular, or both herein, those having skill in the art can translate from the plural to the singular, from the singular to the plural, or both as is appropriate to the context. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). In those instances where a convention analogous to “at least one of A, B, or C, et cetera” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or FIGURES, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

### EXAMPLES

### Example 1

Prepare palmitic acid and emulsifier mixture compositions as shown in TABLE 1. A round-bottomed flask fitted with a magnetic stir bar was charged with palmitic acid and polysorbate 80 emulsifier (oleate). The mixture was heated on an oil bath to 80° C. with vigorous stirring and maintained at 80° C. for 30 minutes with vigorous stirring. After 30 minutes, the heat was turned off, stirring continued, and the mixture was allowed to cool to room temperature. A uniform solid was formed even before reaching room temperature and the flask was maintained at room temperature for 24 hrs. The solid mass formed was crushed using a spatula and transferred to a vial. Melting points of the mixtures of Palmitic acid with polysorbate 80 were determined using a melting point apparatus.

TABLE 1
Melting point of PrimaFat16E compositions

| | | Melting Points (° C.) |
|---|---|---|
| | Mixture (expressed as wt. % of | Mean of three MP |
| Sample | polysorbate 80) | measurement |
| 030A | 5% | 70-71 |
| 030B | 10% | 69-70 |
| 030C | 15% | 69-70 |
| 030D | 20% | 68-69 |
| 030E | 25% | 68-69 |
| 030F | 30% | 67-68 |
| 030G | 35% | 67-68 |
| 030H | 40% | 67-68 |
| 030I | 45% | 67-68 |
| 030J | 50% | 67-68 |

### Example 2

Palmitic acid (950 g) and polysorbate 80 (50 g) was charged into a three liter beaker and was slowly heated in an oil bath to 80° C. over a period of 4-5 hrs until a uniform clear liquid was formed. The contents were maintained at 80° C. for 30 minutes with vigorous stirring. The heating was stopped and the contents were allowed to come to room temperature over a period of 24 hrs. The solid mass was cut into chunks with a knife and crushed to small pieces with a hammer and finally crushed into a fine powder using a blender. The result mixture has a melting point 69-70° C.

### Example 3

A mixture of palmitic acid and stearic acid (6/4 w/w) (950 g) and polysorbate 80 (50 g) was charged into a three liter beaker and was slowly heated in an oil bath to 80° C. over a period of 4-5 hrs until a uniform clear liquid was formed. The contents were maintained at 80° C. for 30 minutes with vigorous stirring. The heating was stopped and the contents were allowed to come to room temperature over a period of 24 hrs. The solid mass was cut into chunks with a knife and crushed to small pieces with a hammer and finally crushed into a fine powder using a blender. The mixture has a melting point 57-58° C.

The embodiments of the invention in which an exclusive property or privilege is claimed are defined as follows:

1. A fatty acid composition for animal feed, comprising a fatty acid component and a surfactant component,
wherein the fatty acid composition melts at not less than 40° C.; and
wherein the fatty acid component has an Iodine Value not greater than 45.

2. The fatty acid composition of claim 1, wherein the fatty acid composition is formed as prilled solid beads or solid flakes.

3. The fatty acid composition of claim 2, wherein the solid bead comprises an outer layer and an inner core, wherein the percentage of the surfactant component in the outer layer is substantially similar to the percentage of the surfactant component in the inner core.

4. The fatty acid composition of claim 2, wherein the solid bead comprises an outer layer and inner core, wherein the percentage of the surfactant component in the outer layer is higher than the percentage of the surfactant component in the inner core.

5. The fatty acid composition of claim 2, wherein the solid bead comprises an outer layer and inner core, wherein the percentage of the surfactant component in the outer layer is less than the percentage of the surfactant component in the inner core.

6. The fatty acid composition of claim 2, wherein the solid bead comprises an outer layer and inner core, wherein the surfactant component in the outer layer differs from the surfactant component in the inner core.

7. The fatty acid composition of claim 2, wherein the solid bead comprises an outer layer and inner core, wherein the fatty acid component in the outer layer differs from the fatty acid component in the inner core.

8. The fatty acid composition of claim 1, wherein the fatty acid composition melts at not less than 60° C.

9. The fatty acid composition of claim 1, wherein the fatty acid composition has a particle size from about 10 μm to about 2 mm.

10. The fatty acid composition of claim 1, wherein the fatty acid composition has an average particle size of about 1 mm.

11. The fatty acid composition of claim 1, wherein the fatty acid composition has a mean particle size of about 1 mm.

12. The fatty acid composition of claim 1, wherein a weight/weight ratio of the surfactant component to the fatty acid component is about 1:100 to about 1:1.

13. The fatty acid composition of claim 1, wherein a weight/weight ratio of the surfactant component to the fatty acid component is about 1:20 to about 1:1.

14. The fatty acid composition of claim 1, comprising no more than 15% by weight of the surfactant component.

15. The fatty acid composition of claim 1, comprising from about 0.01% to about 30% by weight of the surfactant component.

16. The fatty acid composition of claim 1, wherein the fatty acid composition further comprises a nutritional agent or a carrier.

17. The fatty acid composition of claim 1, wherein the carrier comprises a porous carrier material.

18. The fatty acid composition of claim 17, wherein the porous carrier material comprises protein, grain, roughage, or metal-organic framework.

19. The fatty acid composition of claim 16, wherein the nutritional agent comprises an antioxidant, a bioactive agent, a flavoring agent, a colorant, a glucogenic precursor, a vitamin, a mineral, an amino acid, a trace element, or derivatives thereof.

20. The fatty acid composition of claim 19, wherein the antioxidant comprises ethoxyquin (1,2-dihydro-6-ethoxy-2,2,4-trimethylquinoline), BHA (butylated hydroxyanisole), BHT (butylated hydroxytoluene), ascorbic acid, ascorbyl palmitate, benzoic acid, calcium ascorbate, calcium propionate, calcium sorbate, citrate acid, dilauryl thiodipropionate, di stearyl thiodipropionate, erythorbic acid, formic acid, methylparaben, potassium bisulphite, potassium metabisulphite, potassium sorbate, propionic acid, propyl gallate, propyl paraben, resin guaiae, sodium ascorbate, sodium benzoate, sodium bisulphite, sodium metabisulphite, sodium nitrite, sodium propionate, sodium sorbate, sodium sulphite, sorbic acid, stannous chloride, sulphur dioxide, THBP (trihydroxy-butyrophenone), TBHQ (tertiary-butylhydroquinone), thiodipinic acid, tocopherols, polyphenol, carotenoid, flavonoids, flavones, quinones, or derivatives thereof.

21. The fatty acid composition of claim 19, wherein the bioactive agent comprises a prebiotic agent, a probiotic agent, or an antimicrobial agent.

22. The fatty acid composition of claim 21, wherein the prebiotic agent comprises fructo-oligosaccahrides, inulin, galacto-oligosaccahride, mannan-oligosaccahride, a yeast, a component of a yeast, a yeast extract, or a combination thereof.

23. The fatty acid composition of claim 21, wherein the probiotic agent comprises lactic acid-producing bacteria, live yeast cells, yeast culture, enzymes, protease, amylase, or a combination thereof.

24. The fatty acid composition of claim 21, wherein the antimicrobial agent comprises monensin, bambermycin, lasalocid, salinomycin, a sesquiterpene, a terpene, an alkaloid, an essential oil, or their derivative thereof.

25. The fatty acid composition of claim 19, wherein the glucogenic precursor is glycerol, propylene glycol, propanediol, polyol, calcium or sodium propionate, or a derivative thereof.

26. The fatty acid composition of claim 19, wherein the vitamin is biotin, vitamin A, vitamin C, vitamin D, vitamin E, vitamin H, vitamin K, vitamin B₁, vitamin B₂, vitamin B₃, vitamin B₅, vitamin B₆, vitamin B₇, vitamin B₉, vitamin B₁₂, or vitamin Bₚ or derivative thereof.

27. The fatty acid composition of claim 19, wherein the mineral is a derivative of calcium, sodium, magnesium, phosphorous, potassium, manganese, zinc, selenium, copper, iodine, iron, cobalt, or molybdenum.

28. The fatty acid composition of claim 19, wherein the mineral is an amino acid chelated or glycinated mineral or selenium yeast.

29. The fatty acid composition of claim 19, wherein the mineral is an organic mineral derivative.

30. The fatty acid composition of claim 19, wherein the amino acid is carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, selenomethionine, serine, tyrosine, or derivatives thereof.

31. The fatty acid composition of claim 1, wherein the surfactant component comprises a non-ionic emulsifier.

32. The fatty acid composition of claim 1, wherein the surfactant component comprises an ionic emulsifier.

33. The fatty acid composition of claim 1, wherein the surfactant component comprises an emulsifier having a hydrophilic-lipophilic balance value of about 5 to about 25.

34. The fatty acid composition of claim 1, wherein the surfactant component comprises an emulsifier having a hydrophilic-lipophilic balance value of about 15.

35. The fatty acid composition of claim 1, wherein the surfactant component comprises lecithin, soy lecithin, cephalin, castor oil ethoxylate, sorbitan mono-, di-, or trioleate, polysorbitan mono-, di- or trioleate, tallow ethoxylate, lauric acid, polyethylene glycol, or derivatives thereof.

36. The fatty acid composition of claim 1, wherein the surfactant component comprises calcium stearoyl dilaciate, glycerol ester, polyglycerol ester, sorbitan ester, polysorbitan ester, polyethylene glycol ester, sugar ester, mono-, di-, or triglyceride, acetylated monoglyceride, lactylated monoglyceride, or derivatives thereof.

37. The fatty acid composition of claim 1, wherein the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, polysorbate 20, polysorbate 40, polysorbate 60, or derivatives thereof.

38. The fatty acid composition of claim 37, wherein the sodium or potassium or calcium salts of fatty acids comprises sodium or potassium or calcium salts of distilled palm fatty acids.

39. The fatty acid composition of claim 1, wherein the surfactant component comprises a surfactant derived from oleic acid.

40. The fatty acid composition of claim 1, wherein the surfactant component comprises a non-ionic oleate ester derived surfactant.

41. The fatty acid composition of claim 1, wherein the surfactant component comprises an ionic oleic acid derived surfactant.

42. The fatty acid composition of claim 1, wherein the surfactant component comprises sodium oleate, potassium oleate, calcium oleate, ammonium oleate, sorbitan oleate, sorbitan trioleate, glyceryl oleate, methyl oleate, ethyl oleate, PEG oleate, triethanolamine oleate (TEA oleate), polysorbitan oleate, or a combination thereof.

43. The fatty acid composition of claim 1, wherein the fatty acid component comprises at least about 80% by weight of free fatty acid.

44. The fatty acid composition of claim 1, wherein the fatty acid component comprises at least 70% of a palmitic acid compound by weight.

45. The fatty acid composition of claim 44, wherein the fatty acid component comprises at least 95% of a palmitic acid compound by weight.

46. The fatty acid composition of claim 44, wherein the palmitic acid compound comprises free palmitic acid, palmitate triglyceride, one or more salts of palmitic acid.

47. The fatty acid composition of claim 46, wherein the salt of palmitic acid comprises sodium palmitate, calcium palmitate, magnesium palmitate, ammonium palmitate, zinc palmitate, aluminum palmitate, copper palmitate, iron palmitate, chromium palmitate, selenium palmitate, or a combination thereof.

48. The fatty acid composition of claim 1, wherein the fatty acid component comprises at least 95% of free palmitic acid by weight.

49. The fatty acid composition of claim 1, wherein the fatty acid component comprises a stearic acid compound.

50. The fatty acid composition of claim 49, wherein the stearic acid compound comprises free stearic acid, stearate triglyceride, sodium stearate, calcium stearate, magnesium stearate, or ammonium stearate.

51. The fatty acid composition of claim 1, wherein the fatty acid component comprises an oleic acid compound.

52. The fatty acid composition of claim 51, wherein the oleic acid compound comprises free oleic acid, an oleic acid ester, mono-, di- or triglyceride of oleic acid, a high oleic oil, or a combination thereof.

53. The fatty acid composition of claim 51, wherein the fatty acid component comprises from about 1% to about 50% by weight of the oleic acid compound.

54. The fatty acid composition of claim 52, wherein the high oleic oil comprises not less than 40% by weight of oleic content.

55. The fatty acid composition of claim 52, wherein the high oleic oil comprises not less than 50% by weight of oleic content.

56. The fatty acid composition of claim 52, wherein the high oleic oil comprises not less than 60% by weight of oleic content.

57. The fatty acid composition of claim 1, wherein the fatty acid component comprises an oil.

58. The fatty acid composition of claim 1, wherein the fatty acid component comprises olive oil, pecan oil, canola oil, peanut oil, macadamia oil, sunflower oil, corn oil, cottonseed oil, flaxseed oil, algal oil, palm oil, soybean oil, grape seed oil, sea buckthorn oil, chicken fat, turkey fat, lard, or a combination thereof.

59. The fatty acid composition of claim 57, wherein the fatty acid component comprises from about 1% to about 50% by weight of the oil.

60. The fatty acid composition of claim 1, wherein the fatty acid component comprises from about 1% to about 40% by weight of canola oil.

61. The fatty acid composition of claim 1, wherein the fatty acid component comprises free palmitic acid and canola oil at a weight/weight ratio from about 50:1 to about 1:1 by weight.

62. The fatty acid composition of claim 1, wherein the fatty acid component comprises unsaponifiable matter no greater than 45% by weight.

63. The fatty acid composition of claim 1, wherein the fatty acid component comprises unsaponifiable matter no greater than 15% by weight.

64. The fatty acid composition of claim 1, wherein the fatty acid component has an Iodine Value not greater than 45.

65. The fatty acid composition of claim 1, wherein the fatty acid component has an Iodine Value of not greater than 30.

66. The fatty acid composition of claim 1, wherein the fatty acid component has an Iodine Value not greater than 15.

67. The fatty acid composition of claim 1, wherein the fatty acid component has an Iodine Value not greater than 5.

68. A method for making a fatty acid composition for animal feed, comprising:
combining a fatty acid component with a surfactant component to provide a fatty acid composition; and
forming the fatty acid composition into solid beads.

69. The method of claim 68, further comprising heating the fatty acid composition into liquid form before forming the fatty acid composition into solid beads.

70. The method of claim 68, wherein the fatty acid component and the surfactant component are combined in liquid form.

71. The method of claim 68, wherein forming the fatty acid composition into solid beads comprising prilling the fatty acid composition into solid beads.

72. A fatty acid composition for ruminant feed, consisting of a fatty acid component and a surfactant component, wherein the fatty acid composition melts at not less than 50° C.; and
wherein the fatty acid component has an Iodine Value not greater than 30.

73. A fatty acid composition for ruminant feed, comprising:
about 70% to about 99.99% by weight of a fatty acid component;
about 0.01% to about 30% by weight of a surfactant component; and
no more than about 2% by weight water, wherein the fatty acid composition melts at not less than 50° C., and wherein the fatty acid component has an Iodine Value not greater than 30.
